(19) United States
(12) Patent Application Publication
(10) Pub. No.: US 2015/0049489 A1
(43) Pub. Date: Feb. 19, 2015

(54) STRUCTURE OF A LED LAMP

(71) Applicant: Shung-Fa Chiang, Nantou (TW)

(72) Inventor: Shung-Fa Chiang, Nantou (TW)

(21) Appl. No.: 13/967,360

(22) Filed: Aug. 15, 2013

(51) Int. Cl. F21V 29/00; F21K 99/00

(52) U.S. Cl. CPC F21V 29/004; F21K 9/50
USPC 362/294

(57) ABSTRACT

The purpose of the present invention is to provide an Improved Structure of a LED Lamp that can adjust its lighting distance and can disassemble its lens rapidly. It consists of a Radiator with its front end's outer surface provided with a First Combination Part and said end's surface installed with a LED Module and its rear end as a Fixing Part and a Lens Unit that can be set on the Radiator's front end separately. It is characterized in that said Lens Unit includes a Lens in an inverted conical frustum and a Lens Fixing Ring that is fixed on the Lens' frustum end. The inner surface of said Lens Fixing Ring has a Second Combination Part that connects with the First Combination Part. Said Fixing Part has at least two Telescopic Rods for adjusting the lighting distance.

### FIELD OF THE INVENTION

The present invention involves an Improved Structure of a LED Lamp, particularly an Improved Structure of a LED Lamp that cm adjust its lighting distance and disassemble its lens rapidly.

### BACKGROUND OF THE INVENTION

In recent years the techniques of LED has flourished continually, granting the LEDs with advantages such as low energy consumption, long service life, small size and rapid reaction, making them popular to consumers. That is why LEDs have been widely used on all lighting equipment.

However, the LEDs have limited lighting range due to having a single lighting direction, which cannot satisfy consumers in many ways. Industries try to satisfy consumers by adding all sorts of lenses on the LEDs to change their light output's brightness and range. However, this method would make the LED's manufacturing more complicated and adding up to the production cost. Also, the LED Lamps available on the market are mostly installed by screw-locking them on the wall, fixing them on a certain position. As such, if the lamp's lighting distance need adjusting, all one has to do is to unscrew the LED Lamp and re-position it on the right spot. However, this method is not only inconvenient, but can also leave keyholes on the wall, which is not a pretty picture.

In response, how to provide an Improved Structure of a LED Lamp that can adjust its lighting distance and can disassemble its lens rapidly has become the main purpose for the present invention to improve.

### SUMMARY OF THE INVENTION

The purpose of the present invention is to provide an Improved Structure of a LED Lamp that can adjust its lighting distance and disassemble its lens rapidly.

To resolve the aforementioned problems and to accomplish the purpose of the present invention, the present invention's technical methods are accomplished as follows: an Improved Structure of a LED Lamp that consists of a Radiator with its front end's outer surface provided with a First Combination Part and said end's surface installed with a LED Module, along with said Radiator's rear end as a Fixing Part. A Lens Unit is set on the Radiator's front end separately and is characterized in that said Lens Unit includes a Lens in an inverted conical frustum and a Lens Fixing Ring that is fixed on the Lens' frustum end. The inner surface of said Lens Fixing Ring has a Second Combination Part that connects with the First Combination Part. Said Fixing Part has at least two Telescopic Rods pivoted for adjusting the lighting distance.

More preferably, the aforementioned Lens Fixing Ring is a translucent Plastic Ring. More preferably, the aforementioned First Combination Part and Second Combination Part are an external screw thread and an internal screw thread structure that can be screwed together.

More preferably, a Lampshade is set between the aforementioned Radiator and said Lens Unit.

More preferably, the aforementioned Lampshade is a hollow-shaped shell with a Perforation set on the surface of the connecting end where said Lampshade and said Radiator connect to each other, while the other end forms into an Opening.

More preferably, a Lampshade Ring with a Third Combination Part on an internal side surface is set between the aforementioned Lampshade and said Lens Unit.

More preferably, the aforementioned Third Combination Part is an internal screw thread structure.

More preferably, a Fixing Cylinder is set on the pivotally connected spot between the aforementioned Fixing Part and Telescopic Rods.

More preferably, a Fixing Unit is pivotally set on the end of each aforementioned Telescopic Rod that is farther from said Fixing Cylinder.

Compared to the present techniques, the present invention's effects are as follows:
1. The present invention can disassemble its lens easily by hand-turning said Lens Unit, improving its convenience.
2. The present invention can adjust the LED Lamp's lighting distance at will via the Telescopic Rods, satisfying consumers' needs.

### BRIEF DESCRIPTION OF THE DRAWINGS

FIG. 1: Schematic Perspective Diagram of the present invention.

FIG. 2: Schematic Exploded Diagram of the present invention.

FIG. 3˜FIG. 4: Assembly Diagram of the present invention.

FIG. 5: First Schematic Implementation Diagram of the present invention.

FIG. 6: Second and Improved Schematic Implementation Diagram of the present invention.

### DETAILED DESCRIPTION OF PREFERRED EMBODIMENT

The Detailed Description of the Preferred Embodiment of the present invention is as shown in the drawings:

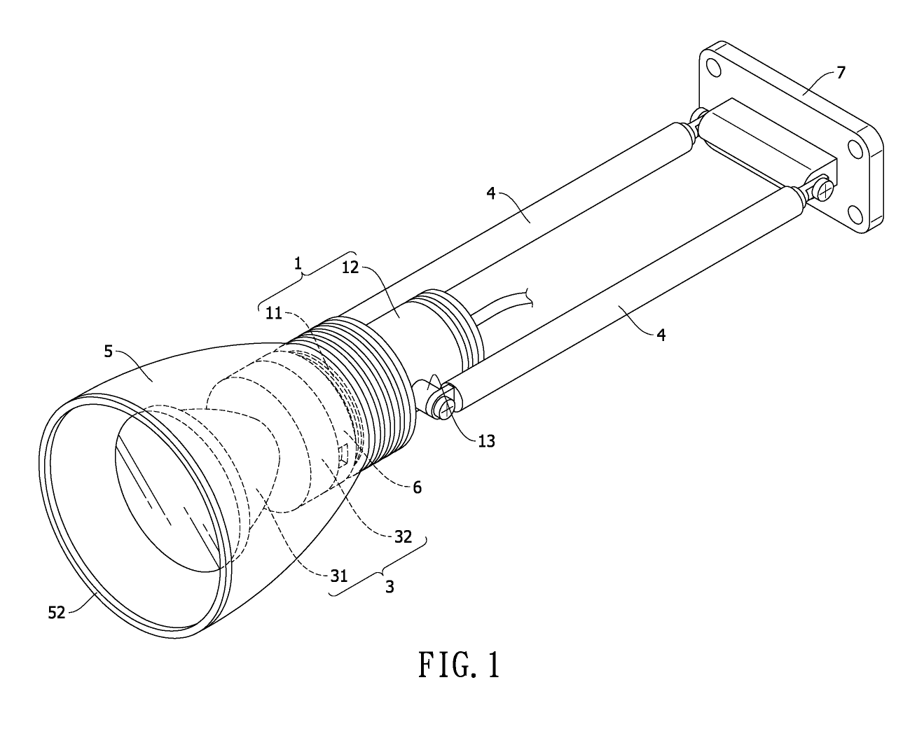

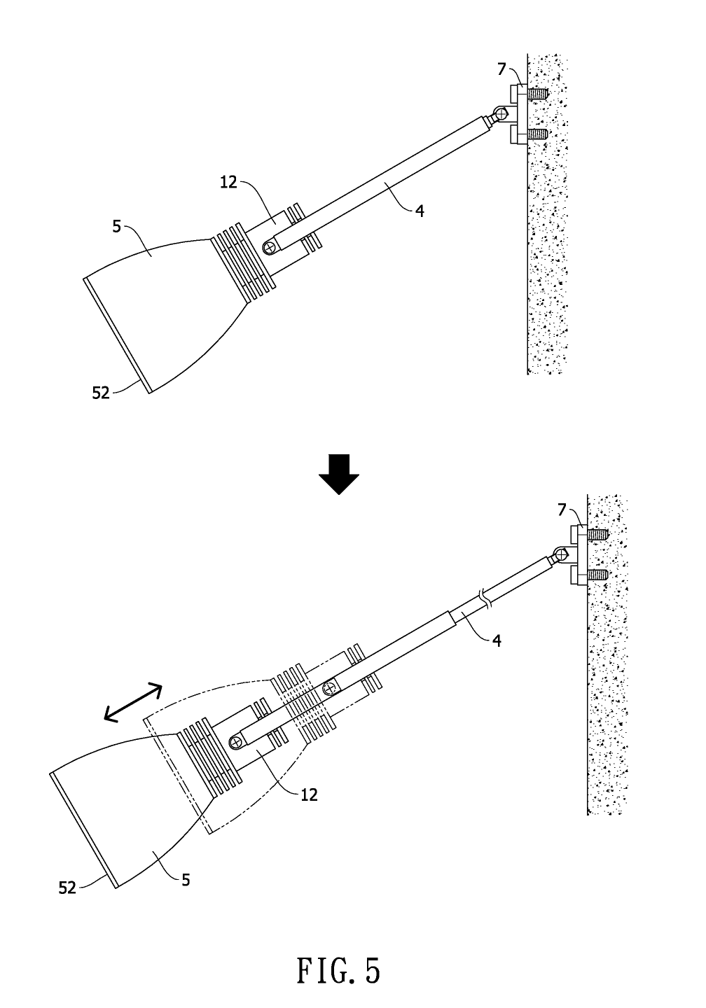

FIGS 1˜6 reveal an Improved Structure of a LED Lamp that consists of a Radiator 1 with its front end's outer surface provided with a First Combination Part 11 and said end's surface installed with a LED Module 2, along with said Radiator's 1 rear end as a Fixing Part 12. A Lens Unit 3 is set on the Radiator's 1 front end separately and is characterized in that said Lens Unit 3 includes a Lens 31 in an inverted conical frustum and a Lens Fixing Ring 32 that is fixed on the Lens' 3 frustum end. The inner surface of said Lens Fixing Ring 32 has a Second Combination Part 321 that connects with the First Combination Part 11. Said Fixing Part 12 has at least two Telescopic Rods 4 pivoted for adjusting the lighting distance. (As shown in FIG. 5)

In which said First Combination Part 11 and Second Combination Part 321 are Combination parts that can be disassembled quickly, allowing said Lens Unit 3 to be disassembled quickly as well, improving the convenience of its replacing.

As mentioned above, the aforementioned Lens Fixing Ring 32 is a translucent Plastic Ring.

In which said Lens Fixing Ring's 32 outer surface can handle fogginess to improve the lighting uniformity.

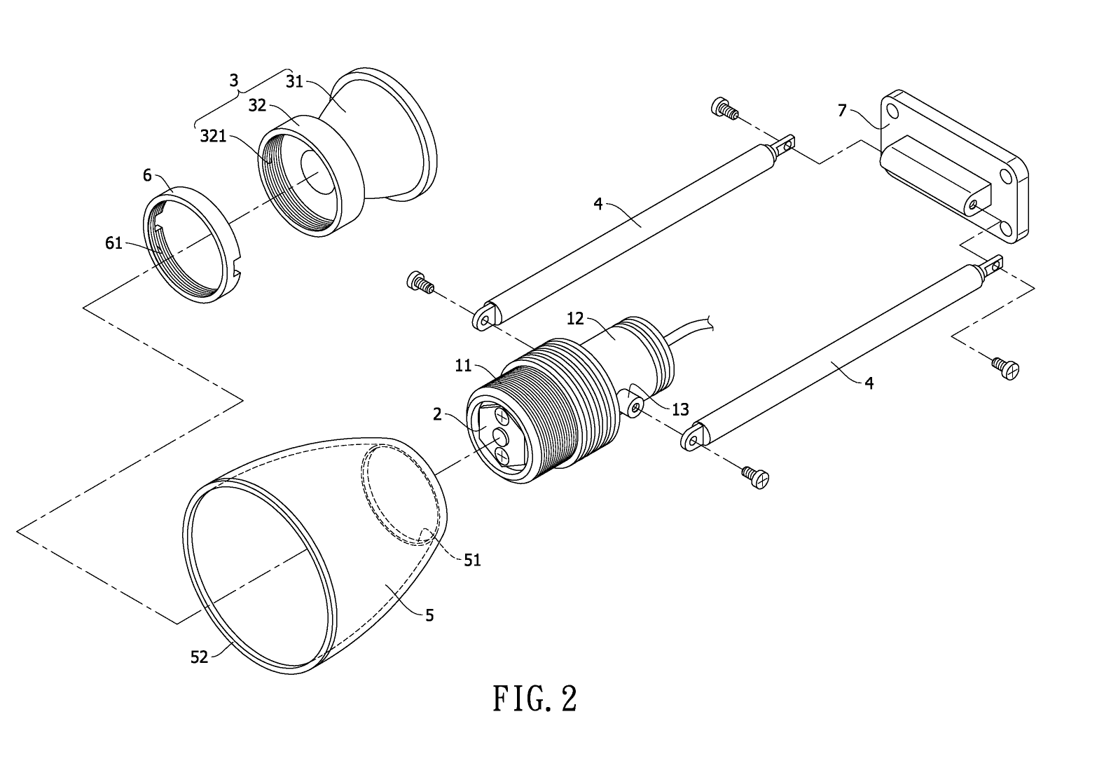

As mentioned above, the aforementioned First Combination Part 11 and Second Combination Part 321 are an external screw thread and an internal screw thread structure that can be screwed together. (As shown in FIG. 2)

In which despite said First Combination Part 11 and Second Combination Part 321 being shown in an external screw thread and an internal screw thread structure in the present embodiment, they can still be shown in other structures with screwing functions and are not limited to the aforementioned screw thread structures.

As mentioned above, a Lampshade 5 is set between the aforementioned Radiator 1 and said Lens Unit 3.

In which said Lampshade 5 is made from semi-transparent material to achieve the effects of softening the effects of the lamp's brightness.

As mentioned above, the aforementioned Lampshade 5 is a hollow-shaped shell with a Perforation 51 set on the surface of the connecting end where said Lampshade 5 and said Radiator 1 connect to each other, while the other end forms into an Opening 52. In which said Lampshade 5 surrounds he LED Module 2 for the light to emit from said Opening 52, improving its brightness.

As mentioned above, a Lampshade Ring 6 with a Third Combination Part 61 on an internal side surface is set between the aforementioned Lampshade 5 and said Lens Unit 3.

In which said Lampshade Ring 6 and said Lampshade 5 are integrally connected to each other.

As mentioned above, the aforementioned Third Combination Part 61 is an internal screw thread structure.

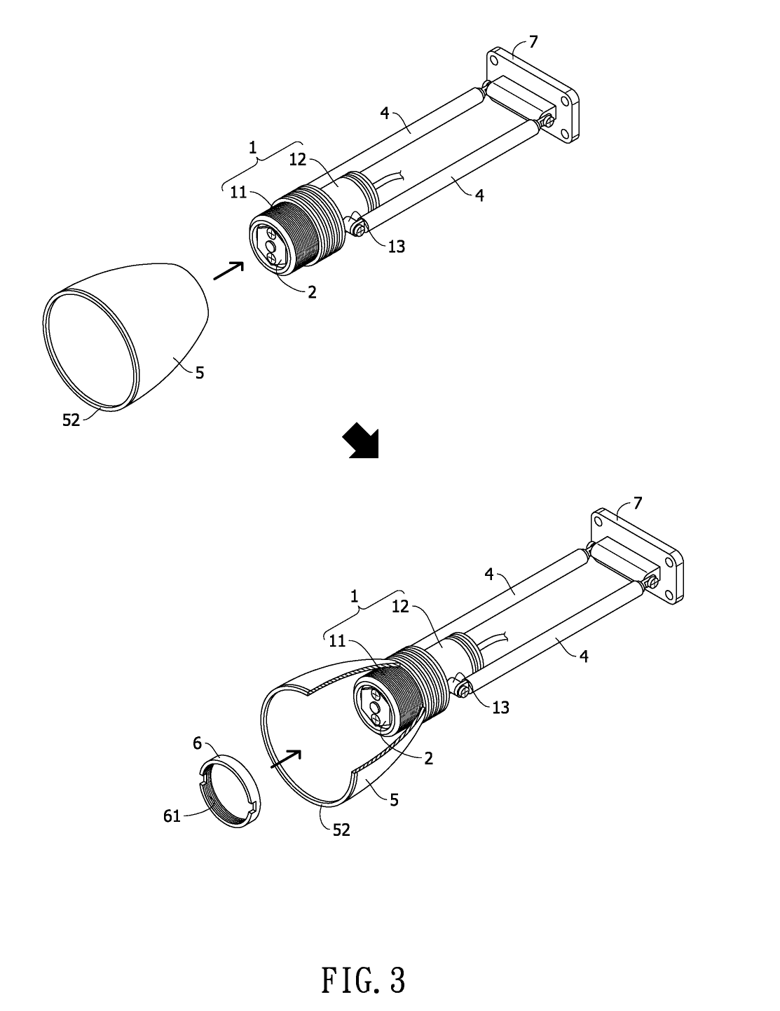

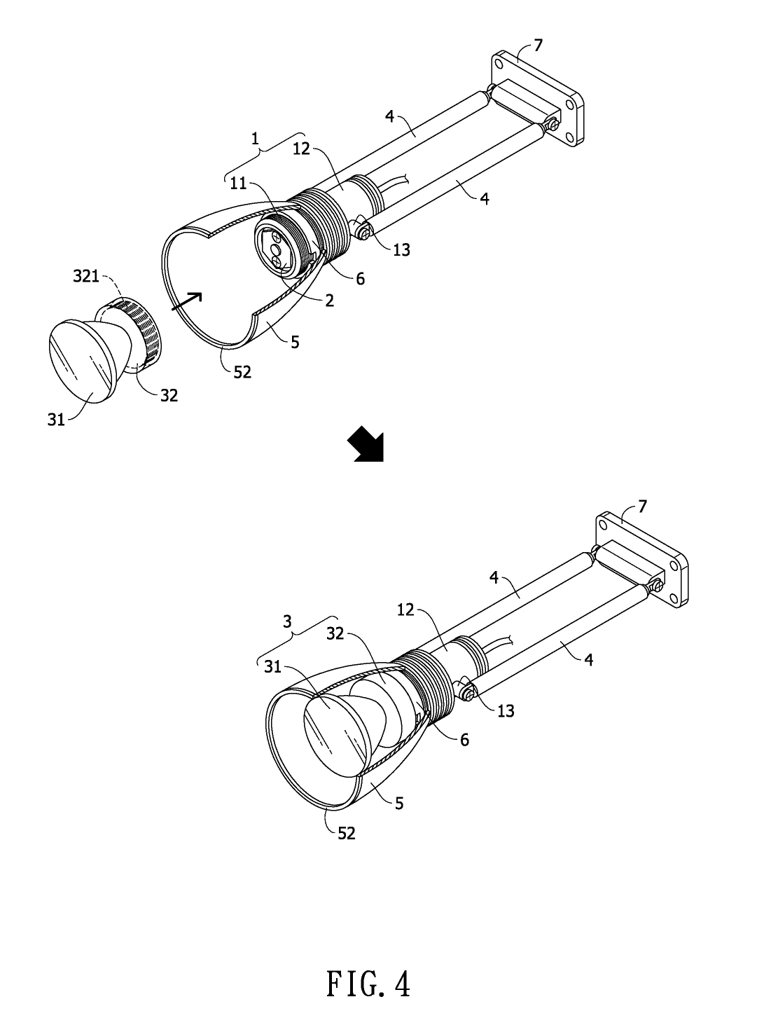

Also, FIG. 3 & FIG. 4 revel that said Third Combination Part 61 and said First Combination Part 11 can be screwed together, allowing said Lampshade 5 to be clamped and fixed between said Lampshade Ring 6 and said Fixing Part 12.

As mentioned above, a Fixing Cylinder 13 is set on the pivotally connected spot between the aforementioned Fixing Part 12 and Telescopic Rods 4.

In which said Fixing Cylinder 13 is radially projecting from said Fixing Part 12, and said Telescopic Rods 4 are pivotally connected on the end of said Fixing Part 12 that is farther from said Fixing Cylinder 13.

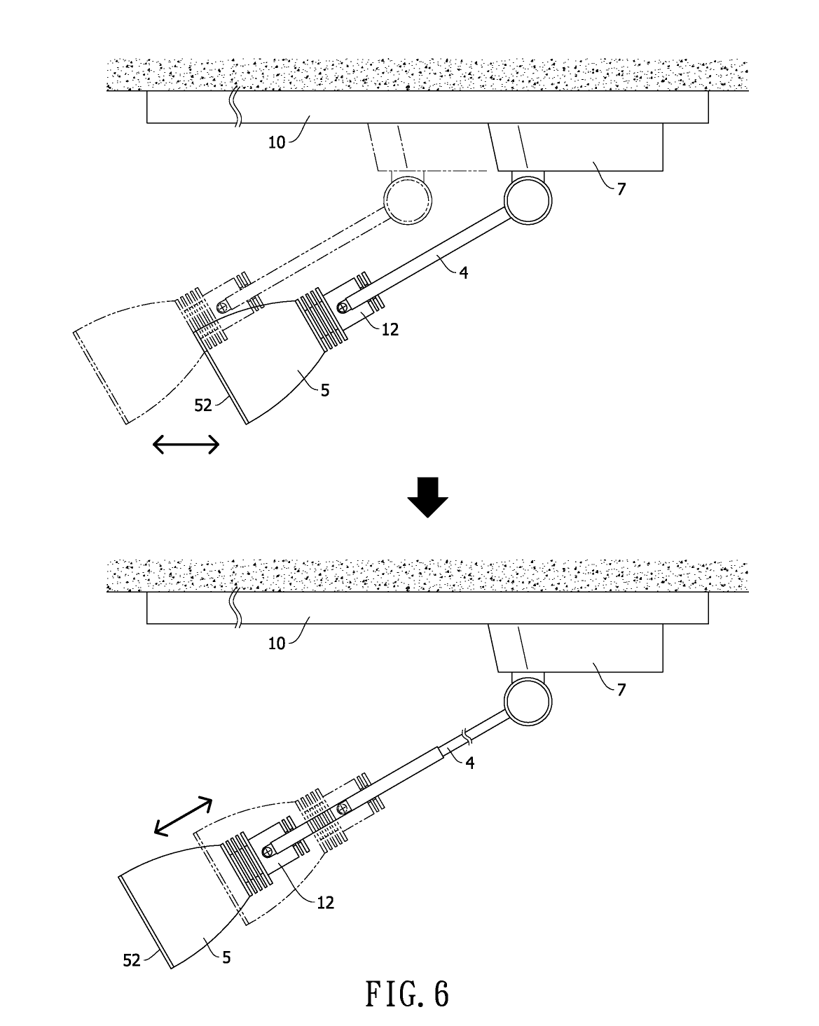

As mentioned above, a Fixing Unit 7 is pivotally set on the end of each aforementioned Telescopic Rod 4 farther from said Fixing Cylinder 13. As shown in FIG. 5, said Fixing Unit 7 can be installed and fixed on the wall and (as shown in FIG. 6) on the Track 10 of regular Track Lightings as well.

In summary, said Lens Unit's 3 design to quickly dissemble and said Radiator's 1 combination improves the present invention's convenience. Said Telescopic Rods 4 can allow the user to adjust the lighting distance of the LED Lamp. Compared to the old LED Lamps, the present invention is of more industrial utilization, more effective, and with more practicality.

All that is described above is the best description of the preferred embodiment for the present invention's structure, characteristics and working effects based on the drawings. As they fulfill the requirements for Novelty and Advancement, we have filed a patent application for the present invention. The present invention's drawings are to describe its best preferred embodiment and not to restrict the present invention's embodiment area. Any improvements or changes for the present invention's structure, characteristics, and principles should be included in the present invention's patent application area.

What is claimed is:

1. An improved Structure of a LED Lamp that consists of:
A Radiator with its front end's outer surface provided with a First Combination Part and said end's surface installed with a LED Module, along with said Radiator's rear end as a Fixing Part.
A Lens Unit is set on the Radiator's front end separately.
It is characterized in that
Said Lens Unit includes a Lens in an inverted conical frustum and a Lens Fixing Ring that is fixed on the Lens' frustum end. The inner surface of said Lens Fixing Ring has a Second Combination Part that connects with the First Combination Part.
Said Fixing Part has at least two Telescopic Rods pivoted for adjusting the lighting distance.

2. The aforementioned Improved Structure of a LED Lamp, as described in claim 1, is characterized in that said Lens Fixing Ring is a translucent Plastic Ring.

3. The aforementioned Improved Structure of a LED Lamp, as described in claim 1, is characterized in that said First Combination Part and Second Combination Part are an external screw thread and an Internal screw thread structure that can be screwed together.

4. The aforementioned improved Structure of a LED Lamp, as described in claim 1, is characterized in that a Lampshade is set between the aforementioned Radiator and said Lens Unit.

5. The aforementioned Improved Structure of a LED Lamp, as described in claim 4, is characterized in that said Lampshade is a hollow-shaped shell with a Perforation set on the surface of the connecting end where said Lampshade and said Radiator connect to each other, while the other end forms into an Opening.

6. The aforementioned Improved Structure of a LED Lamp, as described in claim 4, is characterized in that said Lampshade Ring with a Third Combination Part on an internal side surface is set between the aforementioned Lampshade and said Lens Unit.

7. The aforementioned Improved Structure of a LED Lamp, as described in claim 6, is characterized in that said Third Combination Part is an internal screw thread structure.

8. The aforementioned Improved Structure of a LED Lamp, as described in claim 1, is characterized in that a Fixing Cylinder is set on the pivotally connected spot between the aforementioned Fixing Part and Telescopic Rods.

9. The aforementioned Improved Structure of a LED Lamp, as described in claim 1, is characterized in that a Fixing Unit is pivotally set on the end of each aforementioned Telescopic Rod that is farther from said Fixing Cylinder.
